(19) United States
(12) Patent Application Publication
(10) Pub. No.: US 2007/0022002 A1
(43) Pub. Date: Jan. 25, 2007

(54) System for displaying advertisements on a display monitor at traffic singnals

(75) Inventors: Lakshminarayan Srinivasan, Houston, TX (US); Lee M. McAdory, Katy, TX (US); Jeremy Srinivasan, Katy, TX (US)

Correspondence Address: Clarence E. Eriksen, Suite 2355, 3200 Southwest Freeway, Houston, TX, 77027, US

(73) Assignee: Sterling Systems LLC

(21) Appl. No.: 11/183,141

(22) Filed: Jul. 15, 2005

(51) Int. Cl. G06Q 30/00

(52) U.S. Cl. 705/14

(57) ABSTRACT

A system is disclosed for displaying advertisements on a plurality of display monitors where each display monitor is associated with and mechanically coupled to a traffic signal. The system includes a plurality of display computers where each display computer is operatively connected to one of the display monitors for providing video information to the display monitor to be displayed. A wide area network is operatively coupled to the display computer for use in transmitting video and other information to the display computer. A local area network provides video and other information to the display computers via the wide area network, and a router is operatively connected between the local area and wide area networks for directing information from the local area network to said display computers.

### BACKGROUND OF THE INVENTION

1. Field of the Invention

The present invention relates to a system for use in displaying advertisements on a display monitor attached to a traffic signal.

2. Description of the Prior Art

Every major metropolitan city has a plethora of traffic signals, and these traffic signals perform the function of controlling the flow of vehicular and pedestrian traffic. It would be advantageous to utilize the traffic signal apparatus in connection with the performance of other functions, especially when vehicular and/or pedestrian traffic has come to a stop because of the traffic light on the traffic signal being red in the direction of the pedestrian and/or vehicular traffic. In particular, it would advantageous to be able to display advertisements at the site of traffic signals when the traffic signal has a red light in the direction of the travel. However, to applicants' knowledge, no such system exists.

U.S. Pat. No. 5,917,431 suggested the possibility of a display system for a traffic signal. The display system disclosed in U.S. Pat. No. 5,917,431 comprises a small local area network to which the displays are connected, and it does not describe any way to receive any new data. Additionally, the system described in U.S. Pat. No. 5,917,431 is one in which a memory chip is used for holding data to be displayed, and that system does not describe any way to receive new data. Thus, the system disclosed in U.S. Pat. No. 5,917,431 displays the same information at all times.

It would be advantageous to have a traffic light display system for displaying advertisements that are part of a wide area network allowing the displays to receive data and updates remotely and which utilize computers to contact and receive data from centrally located servers. It would be further advantageous to have a system that is capable of receiving and storing new advertising data for display as well as schedules for the display of such advertisements. These advantageous results have been achieved with the system of the present invention.

### SUMMARY OF THE INVENTION

In accordance with the present invention, a system is provided for displaying advertisements on a plurality of display monitors where each of the display monitors is associated with a traffic signal. The system comprises a plurality of display computers and a display computer is operatively connected to one of the display monitors for providing video information which is to be displayed on that display monitor. A wide area network is operatively coupled to the plurality of display computers and the wide area network is utilized in transmitting video information to the display computers. A local area network is operatively connected to the wide area network via a router to provide video information to the display computers via the wide area network. The router is operatively connected between the local area network and the wide area network and directs the video information from the local area network to at least one of the display computers.

In accordance with the present invention, the local area network comprises a plurality of servers. A first server [data server] comprises a plurality of storage devices for storing files comprising the video information which is to be transferred to at least one of the display computers and which is to be displayed on the display monitor associated with the computer. A system in accordance with the present invention further comprises a second server [database server] which contains files comprising the schedule for displaying files containing the video information. A system in accordance with the present invention may further comprise a third server [heartbeat server] for receiving information from the display computers and for processing that information to ensure that the display computers are functioning properly.

In accordance with the present invention, each of the display computers includes programming to allow the display computer to: (a) interrogate the database in the second server [database server] for the time and date for the video information to be displayed, the name of the video file to be displayed and location on the first server [data server] of the video file to be displayed; (b) retrieve video files from the first server based on the information received from the second server; and (c) display the retrieved files on the display monitor that is associated with that display computer.

A system in accordance with the present invention further comprises a plurality of user computers which provide the information to the second server respecting schedules for display of the advertisements and which provide information to the first server respecting the video information which is to be displayed.

In a system in accordance with the present invention, each user computer includes programming to allow the user computer to: (a) receive input from a user respecting the time and date to display a given video file on a particular display monitor; (b) provide information for storage in the database of the second server [database server] respecting the time and date for the video file to be displayed, the name of the video file to be displayed and location on the first server [data server] of the video file to be displayed and the name of the display computer on which to display the video file; and (c) provide the storage devices of the first server with the video file to be displayed on one of the display monitors.

Each user computer in a system in accordance with the present invention may further be programmed to interrogate the information in the database of the second server respecting schedules of display of video information and to display that information on the user computer. Each user computer may further be programmed to retrieve files respecting video information to be displayed from the first server and to display those files on the user computer.

### BRIEF DESCRIPTION OF THE DRAWING

FIG. 1 is a schematic diagram in block diagram form of a system in accordance with the present invention.

### DESCRIPTION OF SPECIFIC EMBODIMENTS

It will be appreciated that the present invention may take many forms and embodiments. Some embodiments of the invention are described so as to give an understanding of the invention. It is intended that the embodiments of the invention described herein are to be illustrative and not limiting of the invention.

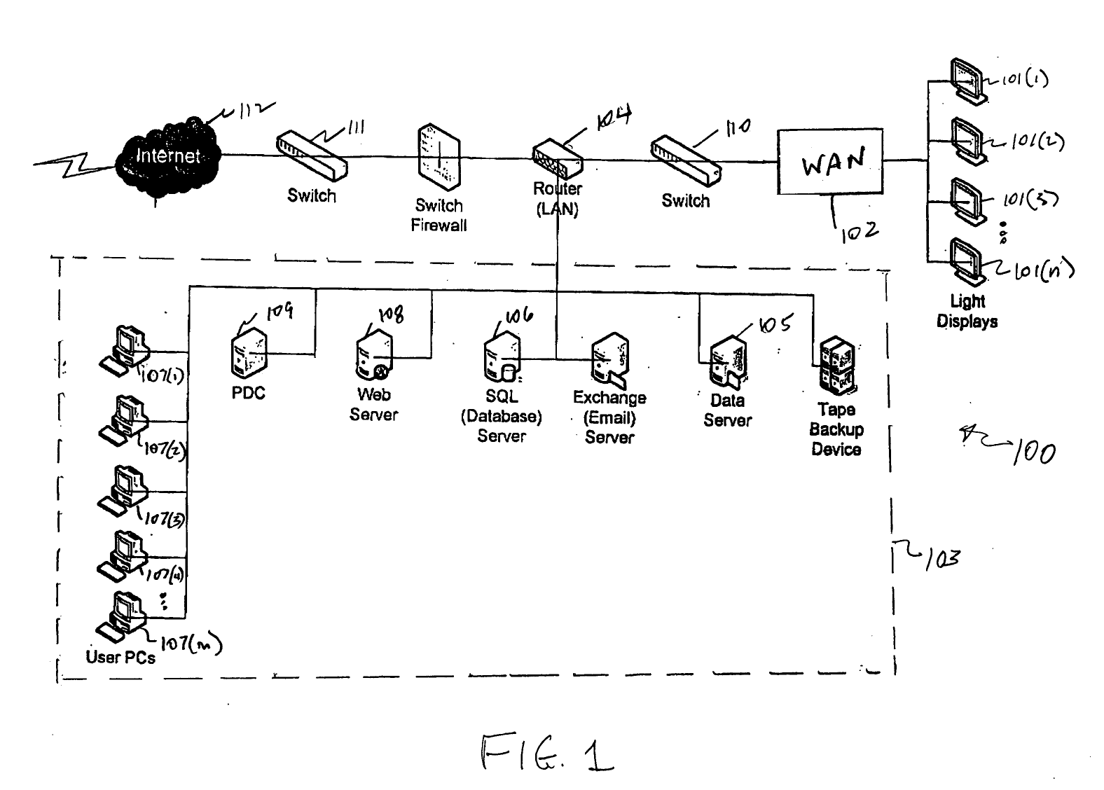

With reference to FIG. 1, a system 100 in accordance with the present invention is illustrated. System 100 comprises a plurality of display computers 101(1), 101(2), 101(3) . . . 101(n). Each such display computer 101(1) through 101(n) includes a display monitor which is associated with a traffic signal and which is mechanically connected to the structure supporting the traffic signal so that the monitor is visible to both vehicular and pedestrian traffic. Each of the display computers 101(1) . . . 101(n) is coupled electronically to a wide area network (WAN) 102, and WAN 102 is the medium utilized in transmitting video information to the display computers 101(1) . . . 101(n). WAN 102 may, for example, be a cable network such as provided by Time Warner.

There are effectively three different types of display monitors that could be used in the system of the present invention. One type of display monitor includes a plasma screen, another type of display monitor includes a liquid crystal display (LCD) screen, and a third type of display monitor includes a light emitting diode (LED) screen. Display monitors having plasma screens or LCD screens appear to be the most advantageous types of screens for use in system in accordance with the present invention.

System 100 in accordance with the present invention also comprises local area network (LAN) 103 which stores and provides video and other information to the display computers 101(1) . . . 101(n) via WAN 102. A router 104 is operatively connected between the LAN 103 and the WAN 102, and the function of router 104 is to direct video information from the LAN 103 to the appropriate display computers 101(1) . . . 101(n) via WAN 102.

The LAN 103 of a system in accordance with the present invention may comprise a first server 105 which is a data server comprising a plurality of storage devices for storing files comprising the video information which is to be transferred to at least one of the display computers 101(1) . . . 101(n) and which is to be displayed on the display monitor associated with that display computer. A system in accordance with the present invention further comprises a second server 106 which is a database server containing files comprising the schedule for display of the files containing video information on the display monitors associated with display computers 101(1) . . . 101(n).

The LAN 103 of system 100 in accordance with the present invention may further comprise a third server [heartbeat server] for receiving information from the display computers 101(1) . . . 101(n) and for processing that information to ensure that the display computers are functioning properly. In one embodiment, each display computer 101(1) . . . 101(n) generates a signal to the third server when the display computer is properly functioning. If that signal is not received by the third server, a technician is alerted.

In accordance with the present invention, each of the display computers 101(1) . . . 101(n) is programmed to interrogate the database in the second or database server for the time, date, name of the video file and location of the video file on the first server; to retrieve the video files from the first server based upon the information received from the second server and to display the retrieved file on the display monitor associated with that display computer.

The LAN 103 of a system 100 in accordance with the present invention may further comprise a plurality of user computers 107(1), 107(2), 107(3), 107(4), . . . 107(m), where m=the number of authorized users. These user computers allow users to provide information to the second server respecting schedules for display of video information and also provide information to the first server respecting the video information to be displayed.

In one embodiment of the present invention, each of the user computers 107(1) . . . 107(m) may be programmed to receive input from a user of the time and date to display a given video file on a particular display monitor; to provide information for storage in the database of the second server respecting the time, date, video file name and location on the first server of the video file and the name of the display computer to display that video file; and to provide the storage devices of the first server with the video file to be displayed on one of the display monitors.

In a system 100 in accordance with the present invention, each user computer 107(1) . . . 107(m) may further be programmed to interrogate the information in the database of the second server respecting schedules for display of video information and to display that schedule information on the user computer. Additionally, each user computer 107(1) . . . 107(m) may be further programmed to retrieve files respecting video information from the first server and to display those files on the user computer.

In one embodiment of a system 100 in accordance with the present invention, the LAN 103 further comprises active directory server 109. This server 109 maintains a directory of authorized users of the system. Once a user enters his or her password into the system, the active directory server 109 permits all applications and services for which the user has been enabled to be available to the user.

Those skilled in the art will appreciate that there a variety of computers, servers and routers that could be used to implement a system in accordance with the present invention. In one embodiment of the present invention, each of the display computers 101(1) . . . 101(n) is a high-end, small form factor type computer. The router 104 in one embodiment of the invention is an integrated software type router. Further, each of the servers in one embodiment of the present invention is a high-end, large capacity type server.

What is claimed is:

1. A system for displaying advertisements on a plurality of display monitors where each said display monitor is associated with and mechanically connected to a traffic signal, comprising:
a plurality of display computers where each said display computer is operatively connected to one of said display monitors for providing video information to the display monitor which is to be displayed on the display monitor;
a wide area network which is operatively coupled to said display computers for use in transmitting video and other information to said display computers;
a local area network which provides video and other information to the display computers via the wide area network; and
a router operatively connected between the local area network and the wide area network for directing the video information from the local area network to at least one of said display computers.

2. The system of claim 1, wherein the local area network comprises a first server [data server] comprising a plurality of storage devices for storing files comprising the video information which is to be transferred to at least one of said display computers and which is to be displayed on the display monitor associated with said display computer.

3. The system of claim 2, wherein the local area network further comprises a second server [database server] containing files comprising the schedule for displaying files containing video information.

4. The system of claim 3, wherein the local area network further comprises a plurality of user computers which provide information to said second server respecting schedules and which provide information to said first server respecting the video information to be displayed.

5. The system of claim 3, wherein the local area network further comprises a third server [Heartbeat server] for receiving information from a display computer and processing that information to ensure that the display computer is functioning properly.

6. The system of claim 3, wherein each display computer is programmed to: (a) interrogate the database in the second server [database server] for the time, date, name of the video file and location of the video file on the first server [data server]; (b) retrieve video files from the first server based on information received from the second server; and (c) display the retrieval file on the display monitor associated with that display computer.

7. The system of claim 4, wherein each user computer is programmed to: (a) receive input from a user of the time and date to display a given video file on a particular display monitor; (b) provide information for storage in the database of the second server [database server] respecting the time, date, video file name, location on the first server [data server] of the video file and the name of the display computer to display the video file; and (c) providing the storage device of the first server with the video file to be displayed on one of the display monitors.

8. The system of claim 7, wherein each user computer is further programmed to interrogate the information in the database of the second server [database server] respecting schedules of display of video information and to display that information on the user computer.

9. The system of claim 7, wherein each user computer is further programmed to retrieve files respecting video information from the first server [data server] and to display those files.
